(19) United States
(12) Patent Application Publication
(10) Pub. No.: US 2026/0149011 A1
(43) Pub. Date: May 28, 2026

(54) FUEL CELL VEHICLE

(71) Applicant: TOYOTA JIDOSHA KABUSHIKI KAISHA, Toyota-shi (JP)

(72) Inventors: Hiroki HABAGUCHI, Toyota-shi (JP); Seiji MIZUNO, Nagoya-shi (JP); Shuhei NAKAMURA, Nisshin-shi (JP); Mitsuaki TOMITA, Toyota-shi (JP); Yuzo MIURA, Toyota-shi (JP); Masahiko MORINAGA, Toyota-shi (JP)

(73) Assignee: TOYOTA JIDOSHA KABUSHIKI KAISHA, Toyota-shi (JP)

(21) Appl. No.: 19/400,032

(22) Filed: Nov. 25, 2025

(30) Foreign Application Priority Data
Nov. 28, 2024 (JP) 2024-207043

(51) Int. Cl. H01M 8/04007; H01M 8/04029; H01M 8/04223; H01M 8/04225; H01M 8/04701

(52) U.S. Cl. CPC H01M 8/04037; H01M 8/04029; H01M 8/04074; H01M 8/04225; H01M 8/04268; H01M 8/04723; H01M 2250/20

(57) ABSTRACT

A fuel cell vehicle comprises a cooling circuit having a radiator and a cooling water pump for cooling a fuel cell stack with cooling water; and a hot water supply circuit having a hot water supply pump and a hot water supply valve for supplying hot water to outside of the vehicle. The hot water supply circuit includes a heat exchanger for performing heat exchange between the cooling water discharged from the fuel cell stack and water in the hot water supply circuit to raise a temperature of the water. An electric heater is disposed in at least one of the cooling circuit and the hot water supply circuit. The electric heater is disposed at one or more of: a first position between a cooling water outlet of the fuel cell stack and a cooling water inlet of the heat exchanger, a second position between a hot water outlet of the heat exchanger and a hot water inlet of the hot water supply valve, and a third position inside a water storage tank provided in the hot water supply circuit.

### CROSS REFERENCE TO RELATED APPLICATIONS

This application claims priority from Japanese Patent Application No. 2024-207043, filed on Nov. 28, 2024, the disclosure of which is incorporated herein by reference in its entirety.

### BACKGROUND

### Field

The present disclosure relates to a fuel cell vehicle capable of supplying hot water to the outside.

### Related Art

JP2018-156792A describes a system that supplies power and hot water to the outside of the vehicle when the vehicle with the fuel-cell and the secondary battery is stopped.

However, in the related art, since the water heater is disposed outside the vehicle, there is a problem that hot water supply cannot be performed by the vehicle alone.

### SUMMARY

According to an aspect of the present disclosure, there is provide a fuel cell vehicle having a fuel cell system including a fuel cell stack. The fuel cell vehicle comprises: a cooling circuit having a radiator and a cooling water pump for cooling the fuel cell stack with cooling water; and a hot water supply circuit having a hot water supply pump and a hot water supply valve for supplying hot water to outside of the vehicle. The hot water supply circuit includes a heat exchanger for performing heat exchange between the cooling water discharged from the fuel cell stack and water in the hot water supply circuit to raise a temperature of the water. An electric heater is disposed in at least one of the cooling circuit and the hot water supply circuit. The electric heater is disposed at one or more of: a first position between a cooling water outlet of the fuel cell stack and a cooling water inlet of the heat exchanger, a second position between a hot water outlet of the heat exchanger and a hot water inlet of the hot water supply valve, and a third position inside a water storage tank provided in the hot water supply circuit.

According to the fuel cell vehicle, it is possible to perform highly efficient hot water supply by the vehicle alone.

### BRIEF DESCRIPTION OF THE DRAWINGS

FIG. 1 is an explanatory diagram showing a configuration of the fuel cell vehicle of a first embodiment;

FIG. 2 is an explanatory diagram illustrating an exemplary arrangement of the fuel cell system and the hot water supply circuit in the vehicle.

FIG. 3 is an explanatory diagram illustrating an exemplary inner configuration of the water storage tank;

FIG. 4 is an explanatory diagram illustrating another exemplary inner configuration of the water storage tank;

FIG. 5 is a flow chart showing the steps of the hot water supply process in the fuel cell vehicle;

FIG. 6 is an explanatory diagram showing the status of the fuel cell vehicle in S16;

FIG. 7 is an explanatory diagram showing the status of the fuel cell vehicle in S20;

FIG. 8 is an explanatory view showing the heat generated by the warm-up operation of the fuel-cell;

FIG. 9 is an explanatory diagram showing a configuration of the fuel cell vehicle of a second embodiment;

FIG. 10 is an explanatory diagram illustrating a configuration of the fuel cell vehicle according to a third embodiment.

### DETAILED DESCRIPTION

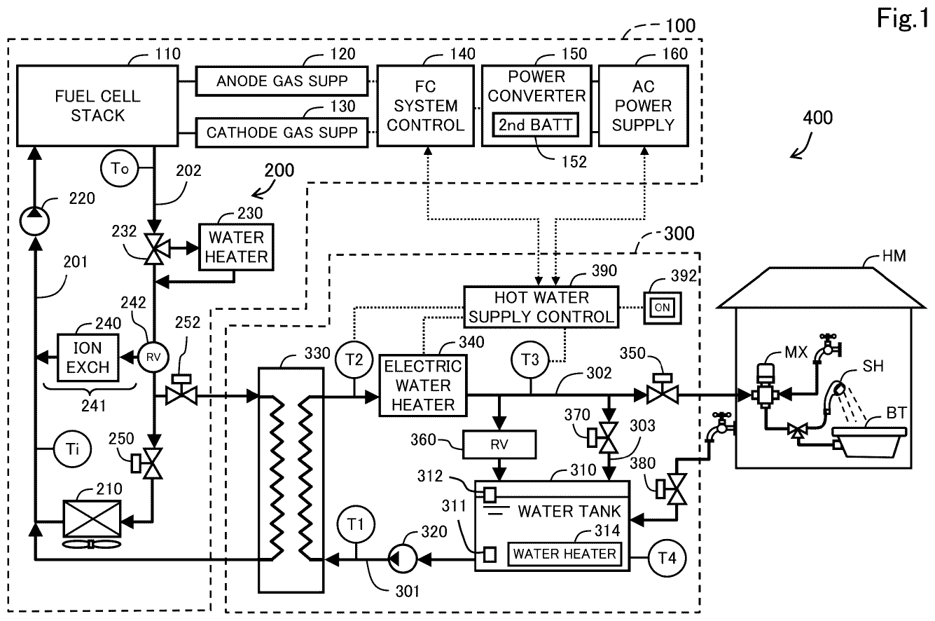

FIG. 1 is an explanatory diagram illustrating a configuration of the fuel cell vehicle 400 according to a first embodiment. The fuel cell vehicle 400 comprises a fuel cell system 100 and a hot water supply circuit 300. The fuel cell vehicle 400 is an electric vehicle using an electric motor as a drive source. The electric motor for driving is driven using the electric power generated by the fuel cell system 100. The fuel cell vehicle 400 is configured as a hot water supply system that heats water in the hot water supply circuit 300 using the energy generated by the fuel cell system 100 and supplies the generated hot water to the outside. Waste heat generated by the fuel cell system 100 is also used to heat the water. That is, the fuel cell vehicle 400 is configured as a FC cogeneration hot water supply system that utilizes both the power generated by the fuel cell system 100 and the waste heat. The fuel cell vehicle 400 can be used, for example, as a nursing-care bathroom.

The fuel cell system 100 includes a fuel cell stack 110, an anode gas supply system 120, a cathode gas supply system 130, an FC system controller 140, a power converter 150 including a secondary battery 152, an AC power supply unit 160, and a cooling circuit 200.

The anode gas supply system 120 provides anode gas to the fuel cell stack 110. The cathode gas supply system 130 supplies cathode gas to the fuel cell stack 110. The anode gas is, for example, hydrogen. The cathode gas is, for example, air.

FC system controller 140 controls each unit of the fuel cell system 100. In FIG. 1, some of the wires that connect FC system controller 140 and the respective units of the fuel cell system 100 are omitted for convenience of illustration. FC system controller 140 is configured as an ECU (Electronic Control Unit) including a processor and a memory.

The power converter 150 includes DC/DC converters and inverters (not shown) In addition to the secondary battery 152. The power converter 150 has a function of converting DC power generated by the fuel cell stack 110 into AC power and supplying the AC power to an electric motor for driving the fuel cell vehicle 400. The power converter 150 further has a function of charging the secondary battery 152 using the DC power generated by the fuel cell stack 110. The secondary battery 152 is used to store the excess power generated by the fuel cell stack 110 and the regenerative power of the drive motor.

The AC power supply unit 160 generates 100V AC power using the power supplied from the power converter 150. For example, AC power supply unit 160 may be configured to generate 100V AC power from the DC power of the secondary battery 152. The 100V AC power can be used as a power source for the electric equipment of the fuel cell vehicle 400. The 100V AC power can also be supplied to the outside of the fuel cell vehicle 400 via a power outlet provided in the fuel cell vehicle 400.

The cooling circuit 200 uses cooling water to cool the fuel cell stack 110. The cooling circuit 200 includes a radiator 210, a cooling water pump 220, a water heater 230, an ion exchanger 240, and a shut-off valve 250.

The cooling water outlet of the radiator 210 and the cooling water inlet of the fuel cell stack 110 are connected by a supply piping 201. The cooling water outlet of the fuel cell stack 110 and the cooling water inlet of the radiator 210 are connected by a discharge piping 202.

A cooling water pump 220 is installed in the supply piping 201. A water heater 230 is connected to the discharge piping 202 via a three-way valve 232. The cooling water heated by the water heater 230 is returned to the discharge piping 202 downstream of the three-way valve 232. A bypass line 241 is provided between the discharge piping 202 and the supply piping 201. An ion exchanger 240 is installed in the bypass line 241. A rotary valve 242 is installed at a connecting portion between the discharge piping 202 and the bypass line 241. The rotary valve 242 is used to regulate the cooling water flow to the bypass line 241.

The discharge piping 202 has a shut-off valve 250 located between the rotary valve 242 and the radiator 210. The shut-off valve 250 is used to halt the flow of cooling water into the radiator 210. The shut-off valve 250 may be located at the outlet of the radiator 210 in the supply piping 201. A flow dividing valve 252 is located between the rotary valve 242 and the shut-off valve 250. The flow dividing valve 252 is used to provide some or all of the cooling water to the heat exchanger 330 of the hot water supply circuit 300.

The supply piping 201 is provided with a temperature sensor for measuring the temperature Ti of the cooling water to be supplied to the fuel cell stack 110. The discharge piping 202 is provided with a temperature sensor for measuring a temperature To of the cooling water discharged from the fuel cell stack 110.

In a normal operating state where no hot water is supplied to the outside of the vehicle, the shut-off valve 250 of the cooling circuit 200 is in the open state and the flow dividing valve 252 is in the closed state. In the normal operating state, the cooling water of the cooling circuit 200 circulates in the cooling circuit 200 through the radiator 210 without passing through the heat exchanger 330. In a hot water supply state in which hot water is supplied to the outside of the vehicle, the shut-off valve 250 is switched to the closed state and the flow dividing valve 252 is switched to the open state. During the hot water supply state, the cooling water in the cooling circuit 200 circulates through the heat exchanger 330 without passing through the radiator 210.

The hot water supply circuit 300 comprises a water storage tank 310, a hot water supply pump 320, the heat exchanger 330, an electric water heater 340, a hot water supply valve 350, a relief valve 360, a circulation valve 370, a feed water valve 380, and a hot water supply controller 390.

The water outlet of the water storage tank 310 and the water inlet of the heat exchanger 330 are connected by an inlet piping 301. The hot water outlet of the heat exchanger 330 and the hot water inlet of the hot water supply valve 350 are connected by a hot water supply piping 302.

The inlet piping 301 has a hot water supply pump 320 located between the water storage tank 310 and the heat exchanger 330. The hot water supply piping 302 has an electric water heater 340 located between the heat exchanger 330 and the hot water supply valve 350. A mechanical relief valve 360 is located between the electric water heater 340 and the hot water supply valve 350. The relief valve 360 has a function of opening the valve when the internal pressure of the hot water supply piping 302 becomes equal to or higher than a valve opening threshold and thereby returning water to the water storage tank 310. The relief valve 360 prevents the hot water supply pump 320 from stopping due to an increase in the internal pressure of the hot water supply piping 302. The hot water supply pump 320 is configured to cease when its discharge pressure exceeds a predetermined pressure. The valve opening threshold of the relief valve 360 is set to be lower than the predetermined pressure of the hot water supply pump 320. The relief valve 360 maintains the internal pressure of the hot water supply piping 302 below the predetermined pressure to prevent the hot water supply pump 320 from stopping.

Between the electric water heater 340 and the hot water supply valve 350 there is provided a circulation piping 303 that returns water from the hot water supply piping 302 to the water storage tank 310. A circulation valve 370 is installed in the circulation piping 303. The circulation valve 370 is used to control whether or not water is returned from the hot water supply piping 302 to the water storage tank 310. The water storage tank 310 is supplied with water from the outside of the vehicle via the feed water valve 380. The hot water supply valve 350 and the feed water valve 380 may be automated valves or manual valves.

Inside the water storage tank 310, a water heater 314 is installed. Inside the water storage tank 310, two water level sensors 311, 312 are further installed. The first water level sensor 311 detects whether the water level of the water storage tank 310 is less than or equal to a predetermined lower limit water level. The second water level sensor 312 detects whether or not the water level of the water storage tank 310 is equal to or higher than a predetermined upper limit water level. The hot water supply controller 390 controls the hot water supply pump 320 and the feed water valve 380 so that the water level of the water storage tank 310 is maintained between the lower and upper water levels. For example, the hot water supply controller 390 shuts down the hot water supply pump 320 when the water level of the water storage tank 310 falls below the lower limit water level. In addition, the hot water supply controller 390 stops supplying water to the water storage tank 310 by closing the feed water valve 380 when the water level of the water storage tank 310 reaches the upper limit water level.

The inlet piping 301 is provided with a temperature sensor for measuring the temperature T1 of the water prior to being heated by the heat exchanger 330. The hot water supply piping 302 is provided with a temperature sensor for measuring the temperature T2 of the water after it has been heated by the heat exchanger 330. Downstream of the electric water heater 340 there is provided a temperature sensor that measures the temperature T3 of the water to be supplied to the outside of the vehicle from the hot water supply valve 350. The water storage tank 310 is provided with a temperature sensor for measuring the temperature T4 of the water in the water storage tank 310.

The hot water supply controller 390 performs control of each part in the hot water supply circuit 300 in accordance with the temperatures T1□T4 of the water in the hot water supply circuit 300. For example, if the temperature T2 of the water at the outlet end of the heat exchanger 330 is less than a target temperature, the hot water supply controller 390 increases the temperature of the water while circulating the water in the hot water supply circuit 300 by maintaining the circulation valve 370 in the valve open state and maintaining the hot water supply valve 350 in the valve closed state. Also, when the temperature T2 of the water at the outlet end of the heat exchanger 330 reaches the target temperature, the hot water supply controller 390 starts supplying hot water to the bath BT by closing the circulation valve 370 and opening the hot water supply valve 350.

The water heater 230, the electric water heater 340, and the water heater 314 are electric heaters. The water heater 230 is located at a first position between the cooling water the outlet of the fuel cell stack 110 and the cooling water inlet of the heat exchanger 330. The electric water heater 340 is located at a second position between the hot water outlet of the heat exchanger 330 and the hot water inlet of the hot water supply valve 350. The water heater 314 is located at a third location within the water storage tank 310 provided in the hot water supply circuit 300. Some of these electric heaters may be omitted, and at least one electric heater is preferably provided. It is also particularly preferred that the hot water supply circuit 300 is configured to heat water using one or more electric heaters. These electric heaters utilize the power generated by the fuel cell stack 110 to heat the water. That is, these electric heaters operate using power supplied from the power converter 150.

In a normal operating state where no hot water is supplied to the outside of the vehicle, the hot water supply valve 350 of the hot water supply circuit 300 is in the closed state and the circulation valve 370 is in the open state. Thus, in the normal operating state, the water of the hot water supply circuit 300 circulates through the water storage tank 310 and the heat exchanger 330 in the hot water supply circuit 300 without being supplied to the outside of the vehicle. In the hot water supply state, the hot water supply valve 350 is switched to the open state and the circulation valve 370 is switched to the closed state.

The hot water supply controller 390 has a function of controlling each unit of the hot water supply circuit 300. In FIG. 1, some of the wires that connect the hot water supply controller 390 and each part of the hot water supply circuit 300 are omitted for convenience of illustration. The hot water supply controller 390 is configured as an ECU including a processor and a memory. The hot water supply controller 390 is configured to efficiently raise the temperature of the hot water supply circuit 300 by coordinating the operation of the fuel cell system 100 and the operation of the hot water supply circuit 300 in cooperation with the FC system controller 140. The functions of the hot water supply controller 390 and the FC system controller 140 may be realized by one ECU. A hot water supply switch 392 is connected to the hot water supply controller 390. When the hot water supply switch 392 is pressed by the user, an operation for supplying hot water from the hot water supply circuit 300 to the outside of the vehicle is started.

The hot water generated by the hot water supply circuit 300 is supplied to the outside of the vehicle via the hot water supply valve 350. In FIG. 1, hot water is supplied to the bath BT and a showerhead SW via a mixing valve MX in home HM, respectively. When the fuel cell vehicle 400 is used as a nursing-care bathroom vehicle, the bath BT is preferably configured as a mobile bath mountable to the fuel cell vehicle 400.

The hot water supply circuit 300 allows water to be circulated in the hot water supply circuit 300 using the hot water supply pump 320 while raising the temperature of the water at the heat exchanger 330. The power generated by the fuel cell stack 110 can also be used to raise the temperature of the water in the hot water supply circuit 300 using the water heater 230, the electric water heater 340, and the electric heater of one or more of the water heater 314.

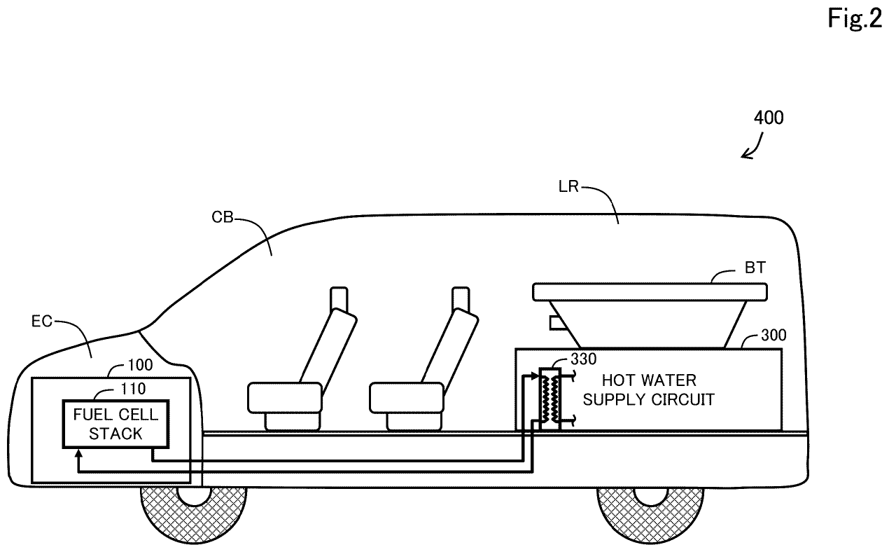

FIG. 2 is an explanatory diagram illustrating an exemplary arrangement of the fuel cell system 100 and the hot water supply circuit 300 in the vehicle. The fuel cell system 100, including the fuel cell stack 110, is disposed in the engine compartment EC of the fuel cell vehicle 400. The hot water supply circuit 300, including the heat exchanger 330, is disposed in the baggage compartment LR behind the cabin CB. The baggage compartment LR also contains the bath BT.

A conventional nursing-care bathing vehicle has a kerosene boiler installed in a baggage compartment LR, so that the cabin CB is not comfortable due to its vibration, smell, and heat. The fuel cell vehicle 400 of the present embodiment is not equipped with a kerosene boiler, and the quiet fuel cell system 100 is arranged in the engine compartment EC that is isolated from the cabin CB, thereby providing a comfortable cabin CB.

When transporting a hot water supply facility using a conventional fuel cell vehicle, heat generated in the fuel cell stack during traveling is discharged from the radiator into the atmosphere, so that the heat generated during traveling cannot be sufficiently utilized. In the fuel cell vehicle 400 of the present embodiment, heat generated in the fuel cell stack 110 during traveling can be transferred to the water of the hot water supply circuit 300 via the heat exchanger 330. In addition, the generated power of the fuel cell stack 110 can be used to heat the water using the electric heaters while the fuel cell vehicle 400 is running. In addition, since the hot water supply circuit 300 provides a water path so that the water can be heated while circulating the water back to the water storage tank 310, the water can be efficiently heated using the heat generated by the electric heaters. Consequently, the fuel cell vehicle 400 is capable of supplying hot water to the outside of the vehicle in a highly efficient and clean manner.

To increase the amount of hot water to supplied to the outside of the vehicle, the generated power of the fuel cell stack 110 can be used to raise the temperature of the water in the hot water supply circuit 300 using one or more of the electric heaters 230, 340, 314. At that time, it is conceivable that power generation efficiency will deteriorate with the increase in power generation volume of the fuel cell stack 110 and the waste heat of the fuel cell stack 110 may increase. However, the waste heat of the fuel cell stack 110 is utilized by the heat exchanger 330 to raise the temperature of the water in the hot water supply circuit 300. Therefore, the fuel cell vehicle 400 of the present embodiment can realize a highly efficient FC cogeneration hot water supply system. Increasing the temperature of the water in the hot water supply circuit 300 may be performed while the fuel cell vehicle 400 is running and may also be performed while the fuel cell vehicle 400 is stopping.

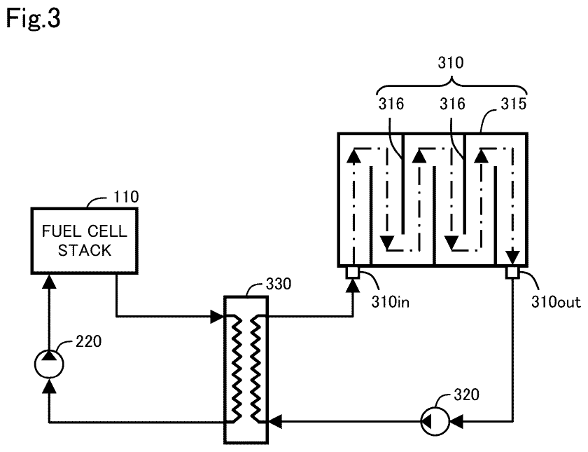

FIG. 3 is an explanatory diagram illustrating an exemplary inner configuration of the water storage tank 310. In FIG. 3, for convenience of illustration, only the fuel cell stack 110, the cooling water pump 220, the heat exchanger 330, and the hot water supply pump 320 are depicted in addition to the water storage tank 310 and associated flow paths. The water storage tank 310 has a box 315 and a partition plate 316 that partitions the interior of the box 315. The water storage tank 310 has a split flow path configuration in which the interior of the box 315 is divided by a plurality of partition plate 316. The path of the water storage tank 310 from the inlet 310in to the outlet 310out is bent in a zigzag manner. The warm water warmed by the heat exchanger 330 flows according to the zigzag-like path of the water storage tank 310. The hot water flows smoothly from the inlet 310in to the outlet 310out without staying in the water storage tank 310 before reaching the heat exchanger 330. Therefore, the heat exchanger 330 can improve the heat-exchange efficiency of the water.

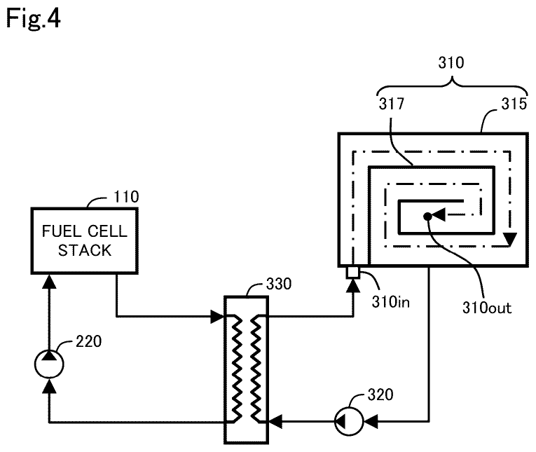

FIG. 4 is an explanatory diagram illustrating another exemplary inner configuration of the water storage tank 310. In this instance, a spiral partition plate 317 is provided inside the box 315 of the water storage tank 310. The path of the water storage tank 310 from the inlet 310in to the outlet 310out is helically bent. The warm water warmed by the heat exchanger 330 flows according to the helical path of the water storage tank 310. The hot water flows smoothly from the inlet 310in to the outlet 310out without staying in the water storage tank 310 before reaching the heat exchanger 330. Therefore, the heat exchanger 330 can improve the heat-exchange efficiency of the water.

In the fuel cell vehicle 400 shown in FIG. 1, with the shut-off valve 250 closed and the flow dividing valve 252 opened in the cooling circuit 200, the cooling water discharged from the cooling water outlet of the fuel cell stack 110 returns to the cooling water inlet of the fuel cell stack 110 via the heat exchanger 330 without passing through the radiator 210. In this state, the thermal energy of the cooling water can be passed to the water of the hot water supply circuit 300 without being dissipated by the radiator 210. On the other hand, the water in the water storage tank 310 is fed by the hot water supply pump 320 to the heat exchanger 330, heated by the heat exchanger 330, and then optionally heated by the electric water heater 340 to return to the water storage tank 310. The efficiency of the heat exchange in the heat exchanger 330 can be improved because the interior of the water storage tank 310 has a bent configuration as shown in FIG. 3 or FIG. 4.

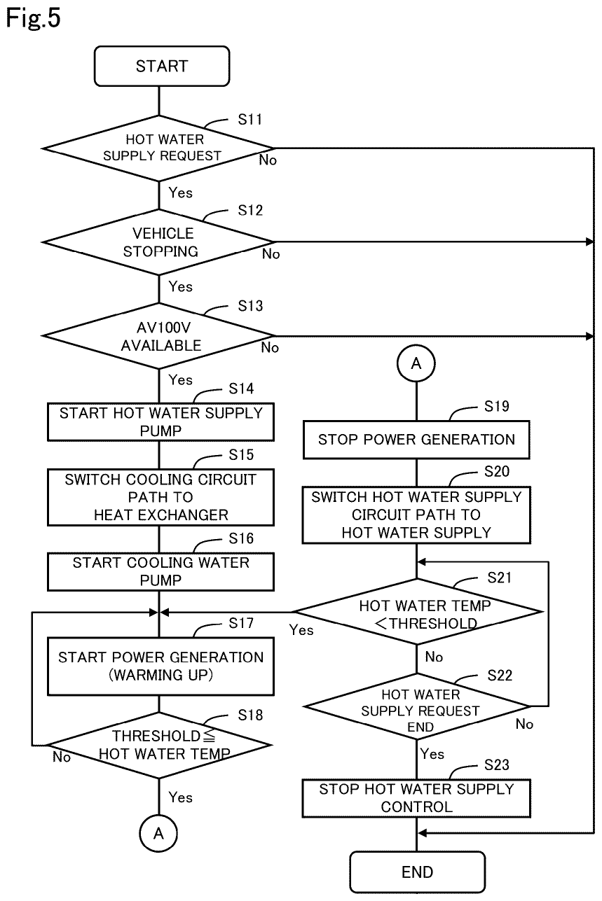

FIG. 5 is a flow chart showing the steps of the hot water supply process in the fuel cell vehicle 400. The process of FIG. 5 is preferably performed periodically at regular intervals.

In S11, the hot water supply controller 390 determines whether there is a hot water supply request from the user. Specifically, when the hot water supply switch 392 is pressed and turned on by the user, the hot water supply controller 390 determines that a hot water supply is requested. When there is no hot water supply request from the user, FIG. 5 process is terminated. If there is a hot water supply request from the user, the process proceeds to S12.

In S12, the hot water supply controller 390 determines whether the fuel cell vehicle 400 is running. Specifically, the hot water supply controller 390 receives, from the travel control unit of the fuel cell vehicle 400, a signal indicating whether or not the fuel cell vehicle 400 is running. If the fuel cell vehicle 400 is running, FIG. 5 process is terminated. If the fuel cell vehicle 400 is stopped, the process proceeds to S13.

In S13, the hot water supply controller 390 determines whether the 100V AC power generated by AC power supply unit 160 is available. If the 100V AC power is not available, FIG. 5 process is terminated. If the 100V AC power is available, the process proceeds to S14. In this embodiment, the 100V AC power is used to operate the equipment in the hot water supply circuit 300. However, the device in the hot water supply circuit 300 may be operated by using the electric power supplied from the power converter 150. In this instance, S13 is omitted.

In S14, the hot water supply controller 390 starts the hot water supply pump 320. In S15, the FC system controller 140 switches the flow path of the cooling circuit 200 to the heat exchanger 330. Specifically, the FC system controller 140 switches the shut-off valve 250 of the cooling circuit 200 to the closed state and switches the flow dividing valve 252 to the open state. Preferably, the FC controller 140 further sets the opening of the rotary valve 242 to 100% so that the total amount of the cooling water passes through the heat exchanger 330 without the cooling water passing through the bypass line 241. The three-way valve 232 may be set such that, for example, the cooling water does not pass through the water heater 230. In S16, FC system controller 140 starts the cooling water pump 220.

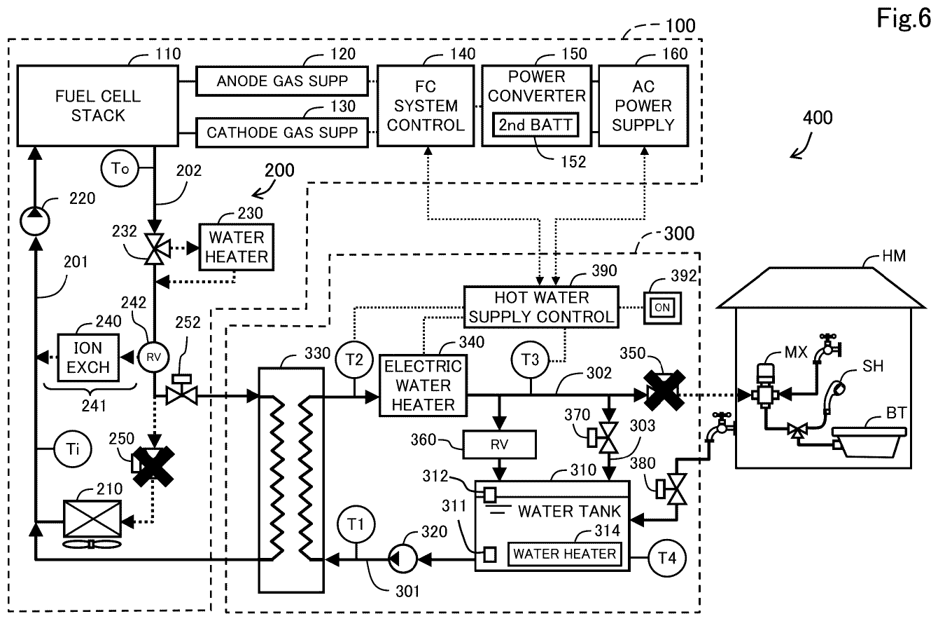

FIG. 6 is an explanatory diagram illustrating the status of the fuel cell vehicle 400 in S16. In this state, the shut-off valve 250 of the cooling circuit 200 is closed and the flow dividing valve 252 is open. Consequently, the cooling water of the cooling circuit 200 circulates in the flow path that passes through the heat exchanger 330 without passing through the radiator 210. The waste heat of the fuel cell stack 110 is provided to the water of the hot water supply circuit 300 via the heat exchanger 330. The hot water supply valve 350 of the hot water supply circuit 300 is closed and the circulation valve 370 is open. Consequently, the water in the hot water supply circuit 300 circulates in a circulation path that includes the circulation piping 303. The circulation path includes a water storage tank 310 and the heat exchanger 330, and circulates the water within the hot water supply circuit 300 while raising the temperature by using heat-exchange in the heat exchanger 330. During the circulation of water in the hot water supply circuit 300, one or both of the electric water heater 340 and the water heater 314 may be used to raise the temperature of the water. The thick “X” drawn above the shut-off valve 250 and the hot water supply valve 350 indicates that these valves are closed. In the piping connected to these valves, some piping portions depicted by a dotted line indicate the portions where water does not flow.

The hot water supply controller 390 is configured to raise the temperature of the water with the heat exchanger 330 while circulating the water in the circulation path of the hot water supply circuit 300 including the circulation piping 303 until the temperature of the hot water that can be supplied to the outside from the hot water supply valve 350 reaches a target temperature. The target temperature is set, for example, in a range of 45° C. to 55° C.

In S17, the FC system controller 140 starts power generation of the fuel cell stack 110. At this time, the fuel cell stack 110 is preferably operated in a warm-up operation mode. The “warm-up operation” is an operation of raising the temperature of the fuel cell stack 110 by utilizing the self-heating caused by the power generation loss of the fuel cell stack 110. The warm-up operation can efficiently raise the temperature of the cooling water in the cooling circuit 200, thereby increasing the heat applied from the cooling water of the cooling circuit 200 to the water of the hot water supply circuit 300 in the heat exchanger 330. As a consequence, warm water can be generated while the power consumed by the electric heaters is suppressed.

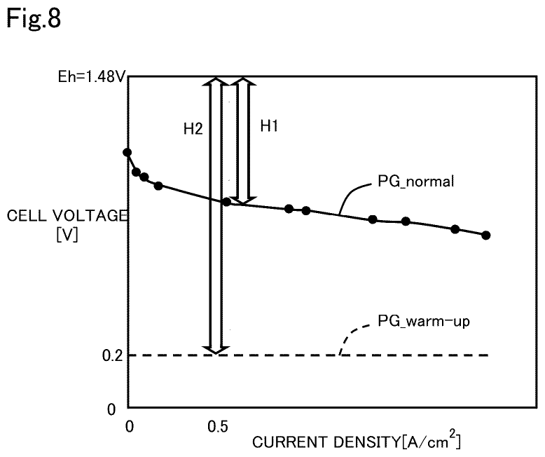

FIG. 8 is an explanatory diagram showing heat generated by the warm-up operation of the fuel-cell. The horizontal axis of FIG. 8 represents the current density of the fuel-cell, and the vertical axis represents the cell voltage per cell. The graph PG_nomal of the solid line shows the characteristics of the normal operation, and the graph PG_warm-up of the broken line shows the characteristics of the warm-up operation. The warm-up operation is an operation in which the fuel cell stack 110 is operated under a power generation condition that is less efficient than the normal operation. Low-efficiency power generation conditions are performed, for example, by reducing the air feed to the fuel cell stack 110 and reducing the air stoichiometry (stoichiometric air-fuel ratio) from the normal operation. In the normal operation, the energy dissipation corresponding to the difference H1 between the theoretical value Eh of the cell voltage and the cell voltage in the normal operation is the waste heat of the fuel cell stack 110. In the warm-up operation, the energy dissipation corresponding to the difference H2 between the theoretical value Eh and the cell voltage in the warm-up operation is the waste heat of the fuel cell stack 110. In the warm-up operation, the waste heat is extremely large compared to the normal operation. Therefore, by executing the warm-up operation of the fuel cell stack 110, the temperature of the water in the hot water supply circuit 300 can be increased while the power consumed by the electric heaters is suppressed.

In winter, the warm-up operation can be performed to heat the water in the hot water supply circuit 300 from 5° C. to 50° C. in about 15 minutes. When the warm-up operation is used, the overall efficiency of the FC cogeneration hot water supply system of the present embodiment is about 75%. On the other hand, the efficiency in the case of raising the temperature of the water by using only the electric power of the normal operation without using the warm-up operation is about 39%. When using the warm-up operation, it is possible to raise the temperature of the water with an efficiency of about twice that of the normal operation, it is possible to start the hot water supply in a shorter time.

In S18, the hot water supply controller 390 determines whether the temperature of the hot water in the hot water supply circuit 300 is greater than or equal to a threshold. For example, the hot water supply controller 390 determines whether a temperature selected from the temperature T3 of the hot water on the outlet side of the heat exchanger 330 and the temperature T4 of the hot water on the inlet side of the hot water supply valve 350 is equal to or higher than a preset threshold. This threshold corresponds to the target temperature of the hot water supplied to the outside of the vehicle. The temperatures T3 and T4 are substantially the same when the electric water heater 340 is not operating or when the electric water heater 340 is not installed. If the temperature of the hot water in the hot water supply circuit 300 is not greater than or equal to the thresholds, the process returns from S18 to S17. If the temperature of the hot water in the hot water supply circuit 300 is greater than or equal to the threshold, the process proceeds to S19.

In S19, the FC system controller 140 stops the power generation of the fuel cell stack 110. In S20, the hot water supply controller 390 switches the flow path of the hot water supply circuit 300 to the hot water supply state. Specifically, the hot water supply controller 390 switches the hot water supply valve 350 from a closed state to an open state and switches the circulation valve 370 from an open state to a closed state. If the hot water supply valve 350 and the circulation valve 370 are manual valves, S20 is performed by the user.

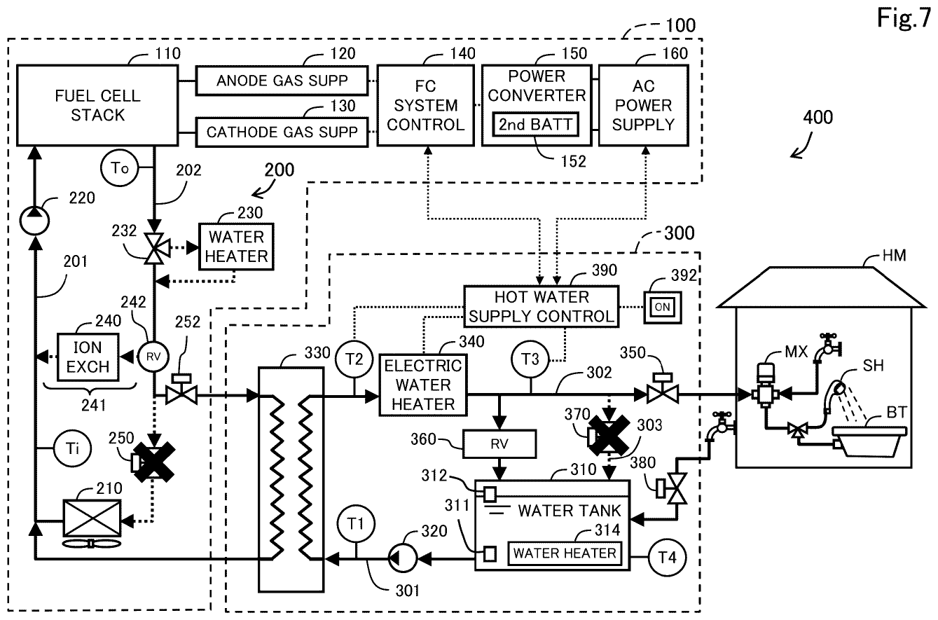

FIG. 7 is an explanatory diagram illustrating the status of the fuel cell vehicle 400 in S20. In this state, the hot water supply valve 350 is open and the circulation valve 370 is closed. Consequently, hot water can be supplied to the outside of the vehicle via hot water supply valve 350.

In S21, the hot water supply controller 390 determines whether the temperature of the hot water in the hot water supply circuit 300 is less than a threshold. As the threshold, the same threshold used in S18 can be used. If the temperature of the hot water in the hot water supply circuit 300 is below the threshold, the process returns to S17 and S17□S20 is performed again. At this time, the hot water supply controller 390 may maintain the hot water supply circuit 300 in a hot water supply state. If the temperature of the hot water in the hot water supply circuit 300 is greater than or equal to the threshold, the process proceeds to S22.

In S22, the hot water supply controller 390 determines whether the user-requested hot water supply has disappeared. Specifically, when the hot water supply switch 392 is switched to the off-state by the user, the hot water supply controller 390 determines that the hot water supply is not requested. If the user-requested hot water supply continues, the process returns to S21. When the user-requested hot water supply disappears, the process proceeds to S23. In S23, the hot water supply controller 390 stops the control related to the hot water supply, and ends the process of FIG. 5.

When raising the temperature of the hot water supply circuit 300 during power generation of the fuel cell stack 110, a portion of the generated power is used as the power of the accessories of the fuel cell vehicle 400 other than the electric heaters 230,340,314. The accessories other than the electric heaters 230,340,314 are, for example, pumps and motors. The remaining generated power is preferably used to heat the water using one or more of the electric heaters 230,340,314. In this way, the generated electric power of the fuel cell stack 110 can be efficiently used to generate hot water.

The shut-off valve 250 of the cooling circuit 200 may be replaced with a control valve, such as a rotary valve. In this case, in the hot water supply state, the FC system controller 140 may set the opening of the control valve 250 and the opening of the flow dividing valve 252 to a value between 0% and 100%, respectively. That is, the flow path in the cooling circuit 200 may be set such that some or all of the cooling water circulates through the heat exchanger 330. For example, if the opening of the control valve 250 is set to be greater than 0% and less than 100%, a portion of the cooling water in the cooling circuit 200 circulates through the heat exchanger 330 and another portion circulates through the radiator 210. This stabilizes the fuel cell stack 110. Further, since the temperature of the cooling water in the cooling water outlet of the fuel cell stack 110 is increased, the temperature of the cooling water inputted to the heat exchanger 330 is increased.

In the process of FIG. 5, hot water is generated while the fuel cell vehicle 400 is stopped, but hot water can also be generated while the fuel cell vehicle 400 is running. Again, the flow path in the cooling circuit 200 may be set such that some or all of the cooling water circulates through the heat exchanger 330. For example, all of the cooling water may be circulated through the heat exchanger 330 rather than through the radiator 210. In this condition, while the fuel cell vehicle 400 is running, the heat exchanger 330 can be used to perform heat-exchange between the cooling water and the water in the hot water supply circuit 300 to raise the temperature of the water in the hot water supply circuit 300. In this way, hot water can be generated by efficiently utilizing the waste heat of the fuel cell stack 110 while the fuel cell vehicle 400 is running.

Since the fuel cell vehicle 400 of the first embodiment is configured as a clean FC cogeneration hot water supply system, hot water can be supplied to the outside of the vehicle by efficiently raising the temperature of the water.

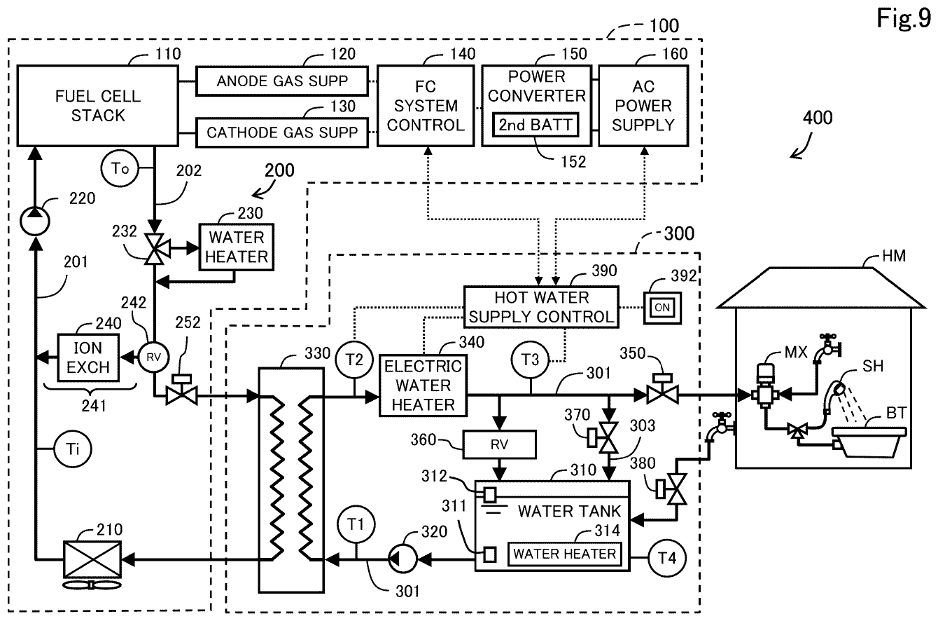

FIG. 9 is an explanatory diagram illustrating a configuration of the fuel cell vehicle 400 according to a second embodiment. The fuel cell vehicle 400 of the second embodiment is configured such that the cooling water of the cooling circuit 200 passes through the heat exchanger 330 at all times by omitting the shut-off valve 250 of the cooling circuit 200 in the first embodiment. The second embodiment also operates substantially in the same manner as the first embodiment. In the second embodiment, when the water of the hot water supply circuit 300 is heated, the cooling water discharged from the cooling water outlet of the fuel cell stack 110 returns to the cooling water inlet of the fuel cell stack 110 through the heat exchanger 330 and the radiator 210 in this order. Thus, prior to heat dissipation in the radiator 210, the thermal energy of the cooling water water can be passed to the water of the hot water supply circuit 300.

In the first embodiment, as described with FIG. 6 and FIG. 7, the circulation path of the cooling circuit 200 can be set so that cooling water circulates through the heat exchanger 330 without passing through the radiator 210. Therefore, in the first embodiment, the waste heat of the fuel cell stack 110 can be more efficiently transferred to the water of the hot water supply circuit 300 than in the second embodiment.

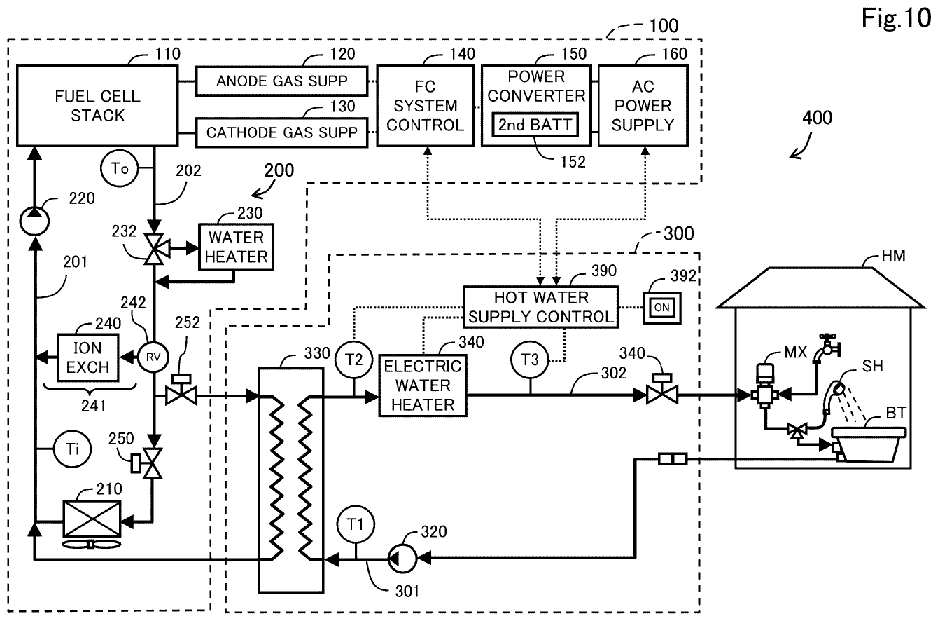

FIG. 10 is an explanatory diagram illustrating a configuration of the fuel cell vehicle 400 according to a third embodiment. In the fuel cell vehicle 400 of the third embodiment, the water storage tank 310 of the first embodiment is omitted. In addition, elements related to the water storage tank 310 are omitted. That is, the relief valve 360, the circulation valve 370, the feed water valve 380, and their pipes are omitted. The inlet end of the hot water supply pump 320 is connected to the bath BT through a pipe. According to this configuration, the water stored in the bath BT can be directly circulated and heated.

### Other Forms

The present disclosure is not limited to the above-described embodiments, and can be realized in various forms without departing from the spirit thereof. For example, the present disclosure can also be realized by the following aspects. The technical features in the above-described embodiments corresponding to the technical features in the respective embodiments described below can be appropriately replaced or combined in order to solve some or all of the problems of the present disclosure or to achieve some or all of the effects of the present disclosure. In addition, if the technical features are not described as essential in the present specification, they can be deleted as appropriate.

(1) According to an aspect of the present disclosure, there is provide a fuel cell vehicle having a fuel cell system including a fuel cell stack. The fuel cell vehicle comprises: a cooling circuit having a radiator and a cooling water pump for cooling the fuel cell stack with cooling water; and a hot water supply circuit having a hot water supply pump and a hot water supply valve for supplying hot water to outside of the vehicle. The hot water supply circuit includes a heat exchanger for performing heat exchange between the cooling water discharged from the fuel cell stack and water in the hot water supply circuit to raise a temperature of the water. An electric heater is disposed in at least one of the cooling circuit and the hot water supply circuit. The electric heater is disposed at one or more of: a first position between a cooling water outlet of the fuel cell stack and a cooling water inlet of the heat exchanger, a second position between a hot water outlet of the heat exchanger and a hot water inlet of the hot water supply valve, and a third position inside a water storage tank provided in the hot water supply circuit.

According to the fuel cell vehicle, it is possible to perform highly efficient hot water supply by the vehicle alone.

(2) In the fuel cell vehicle, the fuel cell system may be configured to increase the temperature of the cooling water by executing a warm-up operation for raising the temperature of the fuel cell stack by utilizing self-heating caused by power generation loss of the fuel cell stack, thereby increasing a heat applied from the cooling water to the water in the hot water supply circuit in the heat exchanger.

According to the fuel cell vehicle, it is possible to raise the temperature of the water in the hot water supply circuit while suppressing the power consumed by the electric heater.

(3) In the fuel cell vehicle, the hot water supply circuit may be configured to increase the temperature of the water in the heat exchanger while circulating the water in a circulation path in the hot water supply circuit until the temperature of the hot water that is suppliable to the outside from the hot water supply valve reaches a target temperature.

According to the fuel cell vehicle, it is possible to easily adjust the temperature of the hot water in the vehicle.

(4) In the fuel cell vehicle, a part of electric power generated by the fuel cell stack may be used to operate accessories other than the electric heater, and the other part of the electric power may be used for heating by the electric heater.

According to the fuel cell vehicle, it is possible to efficiently use the generated electric power of the fuel cell stack to generate hot water.

(5) In the fuel cell vehicle, the heat exchange may be performed between the cooling water and the water in the hot water supply circuit using the heat exchanger during running of the fuel cell vehicle, thereby raising the temperature of the water.

According to the fuel cell vehicle, hot water can be generated by utilizing waste heat of the fuel cell stack while the vehicles are traveling.

The present disclosure can be realized in various forms other than those described above. For example, the present disclosure can be implemented in the form of a fuel cell vehicle control process, a computer program for implementing the fuel cell vehicle control, a non-transitory recording medium (non-transitory storage medium) storing the computer program, and the like.

What is claimed is:

1. A fuel cell vehicle having a fuel cell system including a fuel cell stack, comprising:
a cooling circuit having a radiator and a cooling water pump for cooling the fuel cell stack with cooling water; and
a hot water supply circuit having a hot water supply pump and a hot water supply valve for supplying hot water to outside of the vehicle,
wherein the hot water supply circuit includes a heat exchanger for performing heat exchange between the cooling water discharged from the fuel cell stack and water in the hot water supply circuit to raise a temperature of the water,
wherein an electric heater is disposed in at least one of the cooling circuit and the hot water supply circuit,
wherein the electric heater is disposed at one or more of:
a first position between a cooling water outlet of the fuel cell stack and a cooling water inlet of the heat exchanger,
a second position between a hot water outlet of the heat exchanger and a hot water inlet of the hot water supply valve, and
a third position inside a water storage tank provided in the hot water supply circuit.

2. The fuel cell vehicle according to claim 1, wherein the fuel cell system is configured to increase the temperature of the cooling water by executing a warm-up operation for raising the temperature of the fuel cell stack by utilizing self-heating caused by power generation loss of the fuel cell stack, thereby increasing a heat applied from the cooling water to the water in the hot water supply circuit in the heat exchanger.

3. The fuel cell vehicle according to claim 1, wherein the hot water supply circuit is configured to increase the temperature of the water in the heat exchanger while circulating the water in a circulation path in the hot water supply circuit until the temperature of the hot water that is suppliable to the outside of the vehicle from the hot water supply valve reaches a target temperature.

4. The fuel cell vehicle according to claim 1, wherein a part of electric power generated by the fuel cell stack is used to operate accessories other than the electric heater, and the other part of the electric power is used for heating by the electric heater.

5. The fuel cell vehicle according to claim 1, wherein the heat exchange is performed between the cooling water and the water in the hot water supply circuit using the heat exchanger during running of the fuel cell vehicle, thereby raising the temperature of the water.
